(19) United States
(12) Patent Application Publication
(10) Pub. No.: US 2026/0209480 A1
(43) Pub. Date: Jul. 23, 2026

(54) A PRODUCTION PROCESS FOR TOTALLY BIODEGRADABLE BIOPOLYMER FROM JUTE

(71) Applicant: Shauk Muntaha Murshid KHAN, Wolfsburg (DE)

(72) Inventor: Mubarak Ahmad Khan, Dhaka (BD)

(21) Appl. No.: 19/140,364

(22) PCT Filed: Dec. 17, 2023
(86) PCT No.: PCT/EP2023/086226

§ 371 Date: Jun. 18, 2025

(30) Foreign Application Priority Data
Dec. 18, 2022 (BD) P/BD/2022/00411

(51) Int. Cl. C08L 1/28; C08B 1/06; C08B 11/12; C08J 3/24; C08J 5/18; C08L 29/04

(52) U.S. Cl. CPC C08L 1/286; C08B 1/06; C08B 11/12; C08J 3/246; C08J 5/18; C08L 29/04; C08J 2301/28; C08J 2329/04; C08L 2201/06; C08L 2312/00

(57) ABSTRACT

Jute-based biopolymer has to address both quality and cost issues of the proposed alternative to the single-use plastic. It is claimed as jute cellulose-based biopolymer, 100% biodegradable, compostable, recyclable, eco-friendly. The physical properties of the biopolymer are very much compatible with traditional plastic. It is capable of carrying load by 1.5 times higher with enhanced thermal properties. The mentioned invention is made through very simple formulations and a new casting manufacturing process. A new crosslinking process is mentioned for bonding of cellulose molecules and bio-polymer molecules with low-cost acid and high-temperature control pressure reactor machines. The invention is intended to diminish the rising environmental threats due to the landfilling of plastic waste and the health hazards posed by its disposal.

### CROSS-REFERENCES TO RELATED APPLICATIONS

This application is the US National Phase Entry of Internal Application Serial No. PCT/EP2023/086226 filed on Dec. 17, 2023, which claim priority to Bangladesh Patent Application No. P/BD/2022/00411 filed on Dec. 18, 2022, which are each hereby incorporated herein by reference in its entirety.

### FIELD OF THE INVENTION CROSS

The invention relates to the production process for biopolymer from jute. More particularly the invention closely related to the production of biopolymer sheet which is biodegradable, compostable, recyclable and eco-friendly packaging materials.

### BACKGROUND OF THE INVENTION

The term “Jute cellulose” is strongly highlighted in this discussion of prior arts of invention is meant as environment savior jute plant fiber has great potential importance to supply high range of cellulose within very short time (90-120 days) providing natural polymers for producing bio-mass products in sustainable applications as alternative of oil-based polymers.

In the modern era, awareness of global warming has highlighted the importance of intensive researches on high-performance biodegradable, compostable, environment friendly non toxic materials from renewable resources a low carbon footprint as alternative of fossil-based materials. As the most abundant form of terrestrial biomass, Particular attention has been directed to cellulose based products which could respond to this demand, owing to their renewable origin, excellent mechanical strength, flexibility, easy physical and chemical processing ability as well as permitting the manufacture for a Wide range of applications.

The production of cellulose derivatives has attracted much attention due to the potential characteristics like natural abundance, renewability, recyclability, and ease of accessibility all around the year, around the globe; all make residual biomass an eco-attractive and petro-alternative candidate.

In addition, due to poor mechanical properties of cellulose, several synthetic biodegradable polymers are being used to produce so-called “environment-friendly”. consumer products. Amongst them are starch-based polymers such as poly lactic acid (PLA), polybutylene adipate terephthalate (PBAT), polycaprolactone (PCL), acrylic acid (AAc) blends, polyvinyl alcohol (PVA), etc. However, the emergence of “biodegradable composites” has revolutionized the research in biodegradable materials.

Crosslinking methods is one of the important issues for bonding the different molecules each other. Environment friendly process also highlighted strongly for commercial purpose.

A invention related to the cellulose esters blend discloses the prior are in U.S. Pat. No. 5,594,068A has concerned cellulose derivatives blend composite materials which are useful in the preparation of environmentally nonpersistent, dimensionally stable articles. Such dimensionally stable articles include fibers, nonwovens prepared from said fibers, films, and molded items.

A close prior are disclosed in patent US 2008/0161502 A1 also mentioned a cellulose-based composites materials. The invention discloses the production of cellulose/plastic composites, characterized in that cellulose, more particularly wood, a plastic, more particularly polyvinyl chloride, a compatibilizer containing carboxylic anhydride groups, and a catalyst from the group of heteroaromatic compounds are combined, mixed together, preferably at a temperature in the range from 50° to 130° C.

, and the dry blend obtained is subsequently heated to a temperature above the melting temperature of the plastic, subjected to the desired shaping process, and allowed to cool.

A prior art disclosed in the Hiba Shaghaleh et al. (RSC advances, 2018, volume 8 no. 2, pp. 825-842.) has described the advance potentiality cellulose as alternative of oil-based polymer.

Another prior is disclosed in Rose, M. and Palkovits, R (Macromolecular rapid communications, 2011, Volume 32 no 17, pp. 1299-1311) have strongly emphasized that cellulose has future and current trends as alternative oil-based products.

The existing prior art including the above mentioned art unable to produce totally biodegradable biopolymer and have certain condition mentioned in the following process.

The present invention overcome the drawbacks of the prior art by disclosing the process of production of biopolymer or biopolymer sheets from cellulose particularly from jute cellulose as well as other cellulose containing plants.

### SUMMARY OF INVENTION

The invention comprising the steps of manufacturing process wherein the jute fiber is treated by belching, and scouring, then cellulose is extracted by mercerization and hydrolysis wherein the cellulose purified maintain P^{H} then cellulose derivative is synthesized by dissolving cellulose in isopropyl alcohol (IPA) and chloroacetic acid in alkaline condition afterwards biopolymer solution is prepared by reacting of derivative and biopolymer in acidic condition (P^{H} 4-6) by maintain pressure and temperature wherein the biopolymer solution is casted under belt of silicon cloth in multiple thickness and dry at 60 to 70° C. followed by neutralization by ammonia vapor.

The mentioned invention is made from water soluble jute cellulose derivatives blended with chemo-synthetics bio-polymer (JP20y, Vam and Poval) through simple formulation and manufacturing process. In a preferred embodiment of the invention, the biopolymer that is mixed with cellulose derivatives is polyvinyl alcohol (PVA known as JP20y).

The resulting product is both cost effective and mechanically stable which make it very suitable to solve the global addressed problems of plastic pollution.

### BRIEF DESCRIPTION OF THE DRAWINGS

FIG. 1 shows a schematic diagram of the physical elements of the biodegradable production process.

FIG. 2 shows an architecture diagram of apparatus used for preparation of the biodegradable polymer.

FIG. 3 shows an architecture diagram for apparatus of an exemplary film casting machine.

### DETAILED DESCRIPTION OF THE INVENTION

The invention differs from the prior approaches in both properties and manufacturing aspects. If we consider the differences between the current plastic bags with the jute cellulose based packaging materials the key attribute is the biodegradability.

Jute cellulose based packaging materials degrades in soil within 5-6 months whereas the conventional plastic bags take decades.

Besides, the biodegradability they also differ in hydrophilicity, mechanical strength and elasticity.

Manufacturing processes are also different. Whereas the conventional plastic bags are made by extrusion method, jute cellulose based packaging materials is made of solution casting.

On the other hand, the invented jute cellulose based packaging materials is quite similar in terms of properties and manufacturing process if we compared with hydrophilic biomaterial (e.g. starch) based biodegradable packaging.

However, there are several technical and property based differences. It is made of very cheap jute mill waste the alternative biodegradable bags use different raw materials which mostly are not very cost effective.

Besides, because of using cellulose based materials, it is more stable in moist environment compared with the starch based biodegradable bags.

Cellulose, a natural polymer which makes the cell wall of plants, is selected to make a biodegradable polymer. Jute is a proper source of huge amount of cellulose. About 60 percent cellulose is available in jute fiber with some other components like lignin, hemicellulose, pectin, wax, ash etc. So cellulose extraction from the fiber is first step to conduct this research.

Cellulose is a polysaccharide assembled from glucose monomer unit. The glucose units form a linear molecular chain that possesses extensive networks of hydrogen bonds.

Both the intramolecular and intermolecular bonds within the cellulose chain, the high molecular weight and its crystalline structure make it insoluble in water. Water soluble cellulose derivative is prepared by chemical reaction between cellulose and chloroacetic acid, isopropyl alcohol used as a solvent. The properties of derivatives depend on the number of-OH group that takes part in the substitution reaction. It is an anionic polymer and soluble in water. It makes a viscous solution when dissolve in water and viscosity differs depending on the concentration of the solution.

Another chemo-synthetic biodegradable polymer having chemical formula (C₂H₄O)x), of different molecular weights such as 1,40,000-2,00.000 grams per mole is used. It is also water soluble. A solution of bio-polymer is made first and then mixed with the cellulose derivatives solution.

The chemical structure of biopolymer favors the formation of intramolecular bond.

Acidic condition with mineral acids like hydrochloric acid (HCl), sulfuric acid (H₂SO₄) and some organic acid such as citric acid, acetic acid a pressure reactor is used to promote the crosslinking reaction between cellulose derivatives and biopolymer. Without reactor chamber and acidic condition the reaction between cellulose derivatives and biopolymer is very weak because of less hydrogen bond formation.

With the thermo-chemical crosslinking process, the intermolecular and intramolecular linkage of —OH and —COO—Na in cellulose derivatives molecules make the film less water permeable and less water absorbent.

The film will dissolve quickly in water when there is less crosslinking. It also affects the mechanical property of the film. When crosslinking method is done perfectly, the more tensile strength of the film is observed.

The properties of the film also vary with the variation of the percentage of both the cellulose derivatives and bio-polymer. It is experimentally proved that with increasing cellulose content, unreacted —COOH and —OH group increased, as a result, water molecules are absorbed through hydrogen bonding or weak electrostatic interaction. So, the film could be easily dissipated with water molecules.

On the other hand, with increasing biopolymer content, water uptake of the film increased. In this case, water molecules are absorbed by the unreacted hydrophilic-OH groups of the biopolymer through hydrogen bonding.

The elasticity and the tensile strength of the film are increased with the increasing number of cellulose derivatives and biopolymer molecules, respectively. With the presence thermo-chemical crosslinking condition macromolecules of cellulose derivatives are hydrolyzed into smaller monomer or oligomer, which then reacts with the polymer chain.

The biodegradation test of the film was carried out. Degradation of the film depends on the temperature, pH value and moisture of the soil, microbes that present in the soil and the crystal structure of the film. Microbes helps to degrade the film through breaking down the bonds in it. The acidic condition hinders the degradation of the film. The degradation time vary from I week to 6 months depending on the films property.

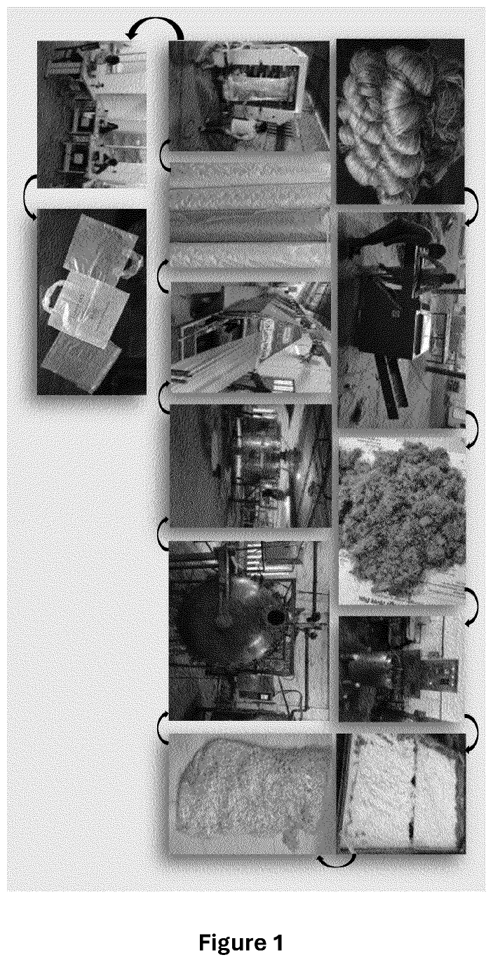

FIG. 1 shows a schematic diagram of the physical elements of the process.

TABLE 1
Characteristics of solution and film preparation.

| | | | Solution | | |
|---|---|---|---|---|---|
| | | | thickness | | |
| Solution | | | during | Temperature | Drying |
| concentration | Density | Viscosity | casting | of conveyor | time |
| 4% | 1.02 | 20.2 centipoise | 1 mm | 70 degree | 30 |
| | gm/cm³ | (30 RPM) | | Celsius. | minutes |

TABLE 2
Characteristics of prepared film

| Film thickness | Film strength | Bag size | Shape of bag |
|---|---|---|---|
| 0.04 mm | 25-40 Mpa | customized | Customized |

### Flow Charts for Key Elements or Steps

| | |
|---|---|
| 1 | Cutting the jute fiber by automatic jute cutting machine. |
| 2 | Jute cellulose extraction by scouring and bleaching. |
| 3 | Lignin separation from black liquor as bi-product. |
| 4 | Washing the cellulose with clean water until it remains P^{H} 7. |
| 5 | Drying by oven |
| 6 | Synthesis of water-soluble cellulose derivative |
| 7 | Solution preparation by automatic feeding system machine |
| | preserving P^{H}, pressure, temperature and time. |
| 8 | Crosslinking of solution by HCI through pressure reactor machine. |
| 9 | Film prepared by film casting. |
| 10 | Film neutralization by ammonia vapor. |
| 11 | Printing by automatic printing machine. |
| 12 | Bag making by glue and ultrasound |

### Extraction of Jute Cellulose

Firstly, dried jute fiber is cut into small pieces by automatic cutting machine. Then, bleached by a low concentrated sodium hypochlorite solution and washing through clean water until it pH7 being neutral. After then concentrated sodium hydroxide solution was used to separate lignin. Again washing through clean water until it remains pH7 being neutral and drying in hot air circulated oven dryer. The cellulose could be extracted from other crops and plant such as Banana, Okura, Pineapple, Water hyacinth, Bamboo and Danchi (Sesbania).

Lignin was collected as bi-product from cellulose extraction process. Filter the cellulose fiber and collect black liquid to extract lignin. Add sulfuric acid into the black liquor drop wise until it remains P^{H} 7. The lignin was precipitated then filters it. Wash with clean water until pH remains 7. Dry the lignin by oven machine and packet for future use.

Synthesis of cellulose derivatives cellulose from jute cellulose well as celluloses extracted from other croups and plants as mentioned. Cellulose derivative from jute cellulose is synthesized by following methods. First of all, 5 g of cellulose powder is weighed and added to 150 ml of isopropanol with continuous stirring. Then, 15 ml of (10%, 15%, 20%, 25% and 30% w/v) NaOH is added dropwise into the mixture and further stirred for an hour at room temperature. The carboxymethylation is started when 6 g of chloroacetic acid is added with continuous stirring for another 1.5 hours. The mixture is covered with aluminum foil and placed into the hot air oven at 60° C. for 3.5 hours. The slurry is subsequently soaked in 100 ml of methanol for overnight. On the next day, the slurry is neutralized with 90% of acetic acid to pH 7 and then filtered using sintered funnel. The final product is washed for three times by soaking in 50 ml of ethanol for 10 minutes to remove undesirable by-products, and then it is washed again with 100 ml of absolute methanol for the last time. The obtained cellulose derivatives from is filtered and dried at 60° C. to constant weight and kept in a dry place. Approximately, 5 g of Cellulose derivatives synthesized earlier with various NaOH concentrations is dissolved in 100 ml of 80° C. of distilled water at constant stirring for 10 minutes. Then, it is centrifuged using an centrifuge machine for 1 minute at 4000 rpm. The dissolved the derivative is re-precipitated in 100 ml of acetone. Recovered the derivative is filtered and dried in a 60° C. oven until constant weight and was kept in desiccators for characterization process.

### Preparation of Bio-Polymer Liquid

Different concentrated solution was used to make biopolymer sheet. Firstly, synthetic polymer biopolymer was dissolved in mixer machine at which used as binder or additives then modified cellulose or the cellulose derivative was added to dissolve in the hot solution. Then food grade color was added. Hydrochloric acid was added as cross linker until the P^{H} of solution was 2-4. Total time for making solution about 2 hours. Ready solution was autoclaved at 110-123° C. for 15-25 minutes to get homogenized solution. Then solution was kept in normal temperature. The ratios of solutes are given below:

TABLE 3
Ratios of different chemicals and relevant parameters.

| | Ratio | | | | Amount of | |
|---|---|---|---|---|---|---|
| | Derivative | | Temperature | Dissolving | color (food | Cross |
| Concentration | biopolymer | Volume | of solution | time | grade) | linker |
| 2-10% | 3:7, 1:1, | 50 | 70° C. | 2-2.5 | 0.5-2 | 250 ml/L |
| | 7:3 | liters | | hours | grams | |

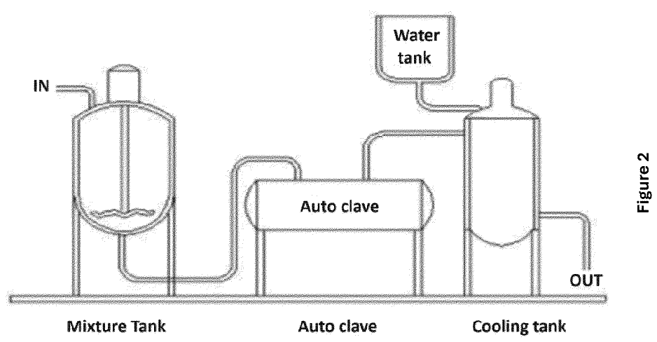

FIG. 2 shows an architecture diagram of bio-polymer liquid preparation.

### Biopolymer Sheet Making Process

The homogenized liquid is casted in conveyor machine for drying. Liquid is casted under belt of silicon cloth in different thickness and dry at 60 to 70° C. Finally, dry film is wrapped by automatic roller machine.

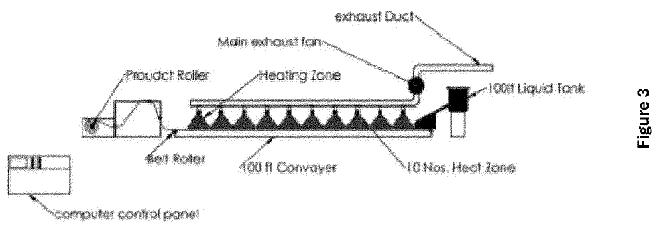

FIG. 3 shows an architecture diagram for systems of film casting machine

### Neutralization Process

Film was neutralized by ammonia vapor by an automatic ammonia treatment plant machine. Then, sheet was dried at 60° C. to remove extra ammonia from sheet surface.

### Bag Making Process

Natural Glue and ultrasound system is developed for sealing of bag. Different types of Shopping bag and packaging materials are made by automatic glue and ultrasound system bag making machine.

“Fully biodegradable” or “totally biodegradable” as used herein, refers to a product or material that, under natural environmental conditions, undergoes a complete decomposition into environmentally benign components, leaving no persistent residues. The term implies that the product or material is capable of breaking down through the action of microorganisms, such as bacteria, fungi, or other biological processes, into compounds that are ecologically compatible and do not pose long-term harm to the environment. The biodegradability of the product or material may be measured and quantified according to established industry standards or testing protocols, demonstrating its ability to return to nature without causing undue harm to ecosystems or creating lasting environmental impact.

“Cellulose derivatives” as used herein refers to compounds derived from cellulose, a linear polymer composed of glucose units linked by β-1,4-glycosidic bonds. The term encompasses a variety of chemical modifications and substitutions made to the cellulose molecule, resulting in altered physical and chemical properties. Such modifications may include, but are not limited to, esterification, etherification, or other chemical transformations of the hydroxyl groups present in the cellulose structure. Examples of cellulose derivatives include cellulose acetate, cellulose ether derivatives such as carboxymethyl cellulose (CMC) and hydroxyethyl cellulose (HEC), and other chemically modified forms that exhibit unique characteristics suitable for various applications, such as pharmaceuticals, food additives, coatings, textiles, and other industrial uses. The cellulose derivatives disclosed herein may be produced through methods known to those skilled in the art, and their specific structures and properties may be varied.

Further embodiments of the present invention are described below:
1. A production process for totally biodegradable biopolymer from jute comprising with the steps of:
   (a) cellulose is extracted from jute fiber;
   (b) cellulose derivative synthesis from cellulose;
   (c) synthesis of biopolymer solution by blending of derivative and biopolymer; and
   (d) casting of bio-polymer sheet
wherein the jute fiber is treated by belching, and scouring, then cellulose is extracted by mercerization and hydrolysis wherein the cellulose purified maintain P^{H} 6.7-7.0 then cellulose derivative is synthesized by dissolving cellulose in IPA and chloroacetic acid in alkaline condition afterwards biopolymer solution is prepared by reacting of derivative and biopolymer in acidic condition (P^{H} 4-6) by maintain pressure and temperature wherein the biopolymer solution is casted under belt of silicon cloth in multiple thickness and dry at 60 to 70° C. followed by neutralization by ammonia vapor.
2. A production process for totally biodegradable biopolymer from jute wherein the biopolymer synthesis is prepared by cellulose derivatives and blending with synthetics biopolymer as in embodiment 1.
3. A production process for totally biodegradable biopolymer from jute wherein synthetics process as in embodiment 1, developed biopolymer solution by blending of the cellulose derivative and biopolymer, hydrochloric acid or acetic acid, or citric acid used as cross-linking agent for attaining the crosslinking density.
4. The production process for totally biodegradable biopolymer from jute as in embodiment 1, wherein synthetics process carried in temperature (110 to 123° C.) for 15-25 minutes and with pressure (2-4 bar).
5. The production process for totally biodegradable biopolymer from jute as in embodiment 1, wherein casting method prepared bio-polymer sheet.
6. The production process for totally biodegradable biopolymer from jute as in embodiment 1, wherein, biopolymer sheet is neutralized by ammonia vapor.
7. The production process for totally biodegradable biopolymer from jute as in embodiment 1, wherein, the biopolymer sheet is sealable by glue and ultrasound system.
8. The production process for totally biodegradable biopolymer from jute as in embodiment 1, wherein, the prepared biopolymer sheet is totally biodegradable, compostable, recyclable, time dependable stability in water, environmentally friendly plastic free and produce's ashes during bum and neither produce toxic gases nor fume.
9. The production process for totally biodegradable biopolymer from jute as In embodiment 1, wherein, (he biopolymer sheet is decomposed in soil within 5-6 months.
10. The production process for totally biodegradable biopolymer from jute as in embodiment 1, wherein, tensile strength the biopolymer sheet is 25-40 MPa.
11. A method for producing a biodegradable polymer from jute fiber comprising the steps of:
   (a) extracting cellulose from jute fiber;
   (b) generating cellulose derivatives from the cellulose;
   (c) generating a solution by mixing cellulose derivatives with a biopolymer; and
   (d) adding a cross-linker to the solution to generate a biodegradable polymer.
12. The method of embodiment 11, further comprising a step of casting of a sheet of the biodegradable polymer.
13. The method of any one of embodiments 11 to 12, wherein the biopolymer is polyvinyl alcohol (PVA).
14. The method of any one of embodiments 11 to 13, wherein the cross-linker is hydrochloric acid (HCl) or acetic acid (CH₃COOH).
15. The method of any one of embodiments 11 to 14, wherein the jute fiber is treated by belching and/or scouring.
16. The method of any one of embodiments 11 to 15, wherein cellulose is extracted by mercerization and/or hydrolysis.
17. The method of any one of embodiments 11 to 16, wherein the cellulose is purified at p^{H} 6.7-7.0.
18 The method of any one of embodiments 11 to 17 wherein cellulose derivatives are synthesized by dissolving cellulose in IPA and chloroacetic acid in alkaline condition.
19 The method of any one of embodiments 11 to 18, where in the biodegradable polymer solution is prepared by reacting cellulose derivatives and cross-linker in acidic conditions (P^{H} 4-6).
20 The method of any one of embodiments 12 to 19, wherein the biodegradable polymer solution is cast under a belt of silicon cloth.
21 The method of any one of embodiments 12 to 20, wherein in the biodegradable polymer solution is cast at multiple thicknesses.
22 The method of any one of embodiments 12 to 21, wherein the biodegradable polymer is dried at 60 to 70° C.
23 The method of any one of embodiments 12 to 22, further comprising a step of neutralizing the biodegradable polymer with ammonia vapor.
24 The method of any one of embodiments 11 to 23, wherein the biodegradable polymer is generated from cellulose derivatives mixed with a synthetic biopolymer.
25 The method of any one of embodiments 11 to 24, wherein the biodegradable polymer is fully biodegradable.
26 The method of any one of embodiments 11 to 25, wherein the solution is generated by mixing of cellulose derivative and a biopolymer.
27 The method of any one of embodiments 11 to 26, wherein hydrochloric acid, acetic acid, or citric acid are used as cross-linking agent for attaining an appropriate crosslinking density.
28 The method of any one of embodiments 11 to 27, wherein the method is carried out at 110 to 123° C.
29 The method of any one of embodiments 11 to 28, wherein the method is carried out for 15-25 minutes.
30 The method of any one of embodiments 11 to 29, wherein the method is carried out under a pressure of 2-4 bar (0.2 to 0.4 MPa).
31 The method of any one of embodiments 11 to 29, wherein the ratio of cellulose derivatives to biopolymer is between 3:7 and 7:3 (for example 1:1).
32 The method of any one of embodiments 11 to 31, wherein the casting step produces a biopolymer sheet.
33 The method of any one of embodiments 11 to 32, further comprising a step of neutralizing the biopolymer sheet with ammonia vapor.
34 The method of any one of embodiments 11 to 33, wherein the biopolymer sheet is sealable by glue and/or ultrasound.
35 The method of any one of embodiments 11 to 34, wherein the biopolymer sheet is totally biodegradable, compostable and/or recyclable.
36 The method of any one of embodiments 11 to 35, wherein the biopolymer sheet is decomposed in soil within 5-6 months.
37 The method of any one of embodiments 11 to 36, wherein the biopolymer sheet has a tensile strength of 25-40 MPa.

1. A method for producing a biodegradable polymer from jute fiber comprising the steps of:
(b) extracting cellulose from jute fiber;
(b) generating cellulose derivatives from the cellulose;
(c) generating a solution by mixing cellulose derivatives with a biopolymer; and
(d) adding a cross-linker to the solution to generate a biodegradable polymer.

2. The method of claim 1, further comprising a step of casting of a sheet of the biodegradable polymer.

3. The method of any one of claims 1 to 2, wherein the biopolymer is polyvinyl alcohol (PVA).

4. The method of any one of claims 1 to 3, wherein the cross-linker is hydrochloric acid (HCl) or acetic acid (CH₃COOH).

5. The method of any one of claims 1 to 4, wherein the jute fiber is treated by belching and/or scouring.

6. The method of any one of claims 1 to 5, wherein cellulose is extracted by mercerization and/or hydrolysis.

7. The method of any one of claims 1 to 6, wherein the cellulose is purified at P^{H} 6.7-7.0.

8. The method of any one of claims 1 to 7 wherein cellulose derivatives are synthesized by dissolving cellulose in IPA and chloroacetic acid in alkaline condition.

9. The method of any one of claims 1 to 8, where in the biodegradable polymer solution is prepared by reacting cellulose derivatives and cross-linker in acidic conditions (P^{H} 4-6).

10. The method of any one of claims 1 to 9, wherein the biodegradable polymer solution is cast under a belt of silicon cloth.

11. The method of any one of claims 1 to 10, where in the biodegradable polymer solution is cast at multiple thicknesses.

12. The method of any one of claims 1 to 11, wherein the biodegradable polymer is dried at 60 to 70° C.

13. The method of any one of claims 1 to 12, further comprising a step of neutralizing the biodegradable polymer with ammonia vapor.

14. The method of any one of claims 1 to 13, wherein the biodegradable polymer is generated from cellulose derivatives mixed with a synthetic biopolymer.

15. The method of any one of claims 1 to 14, wherein the biodegradable polymer is fully biodegradable.

16. The method of any one of claims 1 to 15, wherein the solution is generated by mixing of cellulose derivative and a biopolymer.

17. The method of any one of claims 1 to 16, wherein hydrochloric acid, acetic acid, or citric acid are used as cross-linking agent for attaining an appropriate crosslinking density.

18. The method of any one of claims 1 to 17, wherein the method is carried out at 110 to 123° C.

19. The method of any one of claims 1 to 18, wherein the method is carried out for 15-25 minutes.

20. The method of any one of claims 1 to 19, wherein the method is carried out under a pressure of 2-4 bar (0.2 to 0.4 MPa).

21. The method of any one of claims 11 to 20, wherein the ratio of cellulose derivatives to biopolymer is between 3:7 and 7:3 (for example 1:1).

22. The method of any one of claims 1 to 21, wherein the casting step produces a biopolymer sheet.

23. The method of any one of claims 1 to 22, further comprising a step of neutralizing the biopolymer sheet with ammonia vapor.

24. The method of any one of claims 1 to 23, wherein the biopolymer sheet is sealable by glue and/or ultrasound.

25. The method of any one of claims 1 to 24, wherein the biopolymer sheet is totally biodegradable, compostable and/or recyclable.

26. The method of any one of claims 1 to 25, wherein the biopolymer sheet is decomposed in soil within 5-6 months.

27. The method of any one of claims 1 to 26, wherein the biopolymer sheet has a tensile strength of 25-40 MPa.
